(19) United States
(12) Patent Application Publication
(10) Pub. No.: US 2009/0287616 A1
(43) Pub. Date: Nov. 19, 2009

(54) NON NETWORK CASHLESS HEALTH INSURANCE METHOD

(76) Inventor: Ashish Dave, Ahmedabad, Gujarat (IN)

Correspondence Address: Ashish B Dave, 8 Krishnabaug Colony, Behind Durga High Sschool, Maninagar, Ahmedabad, Gujarat, 380008, IN

(21) Appl. No.: 12/312,806

(22) PCT Filed: Mar. 11, 2008
(86) PCT No.: PCT/IN2008/000139

§ 371 Date: May 28, 2009

(30) Foreign Application Priority Data
Mar. 11, 2007 (IN) 6/MUM/2007

(51) Int. Cl. G06Q 90/00

(52) U.S. Cl. 705/500

(57) ABSTRACT

This method enables the patients to get the best medical treatment that they desire, entitle and deserve according to their will without worrying about cash payments and make them hassle free of reimbursement problems. The insured gives power of attorney to the non-net work hospital or doctor to submit claim, undertake necessary procedure including legal one if required, settle the dispute related to the claim if one such arises, appoint the agent or representative to carry out claim related procedures and assigns the benefits related to the particular claim so that the insurance company or third party administrator company has to pay the claimed amount directly to the said non-network hospital or doctor.

### FIELD OF INVENTION

This invention relates to easy health insurance method by which the patient shall be able to get cash less medical treatment facilities from any medical practitioner of his choice.

### BACKGROUND OF INVENTION

Under the existing available health insurance policies where patient does not pay from the pocket for the medical treatment taken, is commonly known as cashless treatment. Here, in the present system, patient has to undergo treatment at designated hospitals mentioned in the list of the network formed by the insurance company or third party administration companies i.e. third party administrators which are appointed by insurance companies.

In cashless treatment, patient has limited choice of hospitals or doctors and so, he does not get treatment of the quality, which he desires and deserves in view of the above mentioned situation.

This creates immense hardship to the patient as in the present system of cash-less facility, the insured have no right and liberty to select the hospitals or doctors of their choice; rather they are forced to select the hospital or doctor from the network formed by TPA (Third Party Administrators) or insurance company.

Also, at network hospitals or doctors quite often there are unreasonably low package rates fixed by insurance company or third party administrator, which compromises the quality of the medical treatment that the patient is entitled to get under the particular health insurance policy's terms and conditions.

If patient wishes to take treatment at/by non-network hospital/doctor, he has to spend out of his pocket first for the treatment and then file a reimbursement claim for the same. There is a lot of hassle encountered by patients in reimbursement claim like undue delay in claim settlement, illegitimate repudiation, and illegitimate cut in the amount reimbursed.

Hence, main intention of health insurance policy which is to enable the patient to get best medical treatment of his choice is frustrated under existing system.

### OBJECTS OF THE INVENTION

This invention is to provide a method that enables the patients to avail of cash-less treatment from hospital or doctor of their choice irrespective of whether they are empanelled on the network of insurance company or third party administrator.

To give the patients a right and opportunity to choose the doctors and hospital whom they feel the best suitable and best skilled for them.

To enable patients to get best medical treatment that they deserve according to their Health Insurance policies i.e. contract even in the condition of cash-crunch i.e. in which they do not have cash to make up front payment for the treatment.

### DESCRIPTION OF METHOD

The patient shall approach the non-network hospital or a doctor by whom he wants to get treated with cash-less facility.

The insured/patient has to give power of attorney for the particular medical treatment sought, to the hospital or doctor to execute claim and claim related procedure.

The said attorney is also authorized to appoint agent or representative to carry out claim related procedures.

This power of attorney has to authorize the hospital or doctor to submit claim for the particular medical treatment.

This power of attorney has to authorize the hospital or doctor or their agent to carry out claim related procedures with insurers, Third party administrators, insurance regulatory authority, judicial authority and any other related agencies.

This power of attorney has to assign the rights to receive payment related to particular claim to hospital or doctor in their name. Therefore, the hospital or doctor receives the claimed amount for a particular medical treatment rendered to the patient directly from the insurance company or third party administrator.

This power of attorney has to authorize the hospital or doctor to undertake administrative or legal procedure related to the claim, if required and settle the dispute related to the claim if such eventuality arises.

The patient has to furnish an undertaking on his behalf and on behalf of his heirs to pay treatment cost in case of legitimate refusal of claim in accordance with the terms and conditions of particular health insurance policy.

The cash-less treatment is provided for the portion of amount reimbursable according to terms and conditions of particular health insurance policy. The patient pays the amount up front to hospital or doctor wherever, co-payment is required to be paid or deductible is applicable according to the terms and conditions of the policy.

This method, not just being restricted to health insurance, with minor modifications can also be applied to any other general insurance claims where cashless facility is desired.

I claim

1. The method of non-network cashless health insurance authorizing the hospital/doctor by power of attorney given by insured/patient to the hospital or doctor to:
Submit the claim related to the particular medical treatment,
Carry out the required procedures related to claim including the legal one if required,
To enter in to negotiations with insurance company or third party administrator and settle the claim,
Appoint the agent or representative to carry out the procedures related to claim.

2. The method of non network cashless health insurance assigning the benefits related to the claim by insured/patient to the said hospital or doctor of insured/patient's choice so that the insurance company or third party administrator has to make claim payment directly to the hospital or doctor of choice of the insured.

3. The method of non-network cashless health insurance and benefits attached with it.
